(19) United States
(12) Patent Application Publication
(10) Pub. No.: US 2009/0103807 A1
(43) Pub. Date: Apr. 23, 2009

(54) MULTI-IMAGER DISPLAY APPARATUS

(75) Inventor: Shaoher X. Pan, San Jose, CA (US)

Correspondence Address: FISH & RICHARDSON P.C., PO BOX 1022, MINNEAPOLIS, MN, 55440-1022, US

(73) Assignee: SPATIAL PHOTONICS, INC., Sunnyvale, CA (US)

(21) Appl. No.: 11/874,676

(22) Filed: Oct. 18, 2007

(51) Int. Cl. G06K 9/34

(52) U.S. Cl. 382/173

(57) ABSTRACT

A display apparatus includes a controller, a first addressing circuit, a first array of displaying elements, a second addressing circuit, a second array of displaying elements, and a reset circuit. The controller can separate a digital image into a first image portion and a second image portion and produce a first control signal based on the first image portion and a second control signal based on the second image portion. The first and the second addressing circuits can respectively produce first and second addressing signals in response to the first and second control signals. The first array of displaying elements displays the first image portion in response to the first addressing signals. The second array of displaying elements displays the second image portion in response to the second addressing signals. A reset circuit can simultaneously reset the first array of displaying elements and the second array of displaying elements.

### BACKGROUND

The present disclosure relates to display technologies.

Large electronic displays are widely used in tradeshows, malls, and certain commercial districts. Because of their large dimensions, these large electronic displays are typically produced by an array of stand-alone display devices that are tiled up together. Each stand-alone display device includes its own controller, addressing circuit, and reset circuit, and can display images on its own. When using stand-alone display devices that are tiled up together, an input digital image is split into multiple portions where each portion is sent to a separate display device. Each of the stand-alone display devices then produces a portion of the large electronic display.

### SUMMARY

In a general aspect, the present disclosure relates to an apparatus for displaying a digital image. The apparatus includes a controller configured to separate the digital image into a first image portion and a second image portion, and to produce a first control signal based on the first image portion and a second control signal based on the second image portion; a first addressing circuit in communication with the controller, the first addressing circuit being configured to produce first addressing signals in response to the first control signal; a first array of displaying elements configured to display the first image portion in response to the first addressing signals; a second addressing circuit in communication with the controller, the second addressing circuit being configured to produce second addressing signals in response to the second control signal; a second array of displaying elements configured to display the second image portion in response to the second addressing signals, wherein the first array of image displaying elements and the second array of image displaying elements are constructed on different substrates; and a reset circuit in communication with the controller, the first array of displaying elements, and the second array of displaying elements, wherein the reset circuit is configured to simultaneously reset the first array of displaying elements and the second array of displaying elements.

In another general aspect, the present disclosure relates to an apparatus for displaying a digital image. The apparatus includes a controller configured to separate the digital image into a first image portion and a second image portion, and to produce a first control signal based on the first image portion and a second control signal based on the second image portion, wherein the controller circuit is constructed on a first substrate; a first addressing circuit in communication with the controller, the first addressing circuit configured to produce first addressing signals in response to the first control signal; a first array of displaying elements configured to display the first image portion in response to the first addressing signals, wherein the first array of displaying elements and the first addressing circuit are constructed on a second substrate that is different from the first substrate; a second addressing circuit in communication with the controller, the second addressing circuit configured to produce second addressing signals in response to the second control signal; a second array of displaying elements configured to display the second image portion in response to the second addressing signals wherein the second array of displaying elements and the second addressing circuit are constructed on a third substrate, which is different from both the first substrate and the second substrate; and a reset circuit in communication with the controller, the first array of displaying elements, and the second array of displaying elements, wherein the reset circuit is configured to simultaneously reset the first array of displaying elements and the second array of displaying elements.

In another general aspect, the present disclosure relates to a method for image display. The method includes separating a digital image into a first image portion and a second image portion; producing a first control signal based on the first image portion and a second control signal based on the second image portion; producing first addressing signals in response to the first control signal and sending the first addressing signals to a first array of displaying elements; displaying the first image portion in response to the first addressing signals; producing second addressing signals by a second addressing circuit in response to the second control signal and sending the second addressing signals to a second array of displaying elements; displaying the second image portion in response to the second addressing signals; and simultaneously resetting the first array of displaying elements and the second array of displaying elements with a single reset signal.

Implementations of the system may include one or more of the following features. The first array of displaying elements and the first addressing circuit can be constructed on a first substrate, and the second array of displaying elements and the second addressing circuit can be constructed on a second substrate and the controller can be constructed on a third substrate, which is different than both of the first substrate and the second substrate. The reset circuit can be constructed on the third substrate. The apparatus can further include a display surface on which a continuous display image is formed by the first image portion and the second image portion. The apparatus can further include a light source configured to provide incident light to at least one of the first array of displaying elements or the second array of displaying elements. The first addressing signals can control the first array of displaying elements based on pixel values in the first image portion. The second addressing signals can control the second array of displaying elements based on pixel values in the second image portion. At least one of the displaying elements in the first array can include a tiltable micro mirror configured to tilt under the control of the first addressing signal and to reflect an incident light to a display surface to form a pixel of the first image portion.

Embodiments may include one or more of the following advantages. The disclosed display apparatus may use fewer components and may thus be more integrated and more compact than some conventional display systems. The disclosed display apparatus can be readily scaled to produce large display images with few components and thus lower cost than some conventional display systems. The disclosed display apparatus may consume less power than some conventional display systems. The disclosed display apparatus may also provide improved synchronization between different portions of a display image, which may improve the quality of the display images.

Although the invention has been particularly shown and described with reference to multiple embodiments, it will be understood by persons skilled in the relevant art that various changes in form and details can be made therein without departing from the spirit and scope of the invention.

### BRIEF DESCRIPTION OF THE DRAWINGS

The following drawings, which are incorporated in and from a part of the specification, illustrate embodiments of the present specification and, together with the description, serve to explain the principles of the specification.

FIG. 1 is a block diagram of a display system.

FIG. 2 is schematic diagram of a pixel array in the display system of FIG. 1.

FIG. 3 illustrates the division of an input digital image into multiple image portions to be displayed by different imagers.

FIGS. 4A and 4B show a flowchart for producing a display image using the display system of FIG. 1.

### DETAILED DESCRIPTION

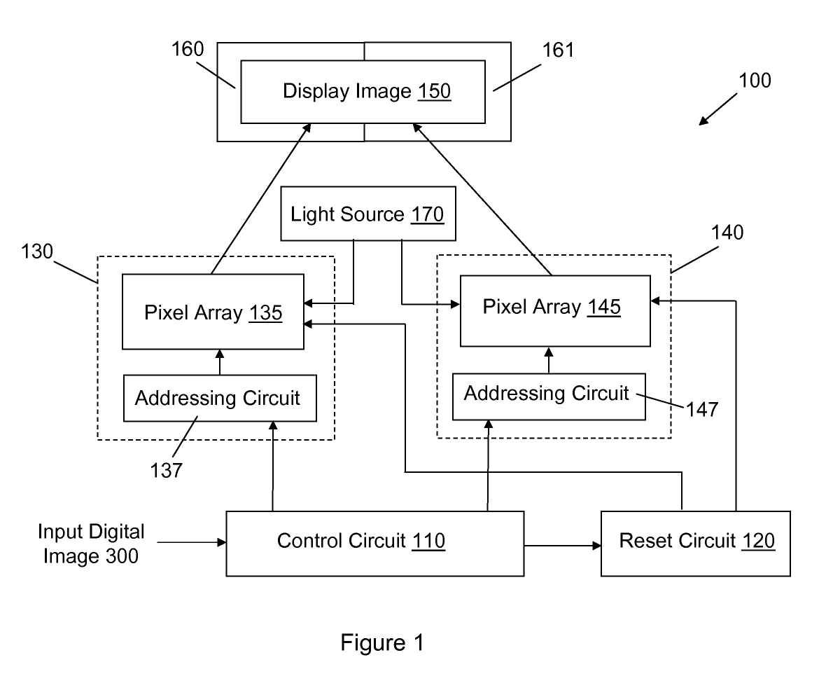

Referring to FIG. 1, a display system 100 includes a control circuit 110 configured to receive an input digital image 300, a reset circuit 120, a first imager 130, and a second imager 140. The first imager 130 includes an addressing circuit 137 and a pixel array 135. The second imager 140 includes an addressing circuit 147 and a pixel array 145. The control circuit 110 receives image data, such as data for a still image or video images. The display system 100 includes a light source 170 that provides incident light to the pixel array 135 and the pixel array 145. Alternatively, the image array 135 and image array 145 have their own separate light sources. Each of the pixel array 135 and the pixel array 145 can produce a portion of a display image 150, which reproduces at least a portion of the input digital image 300. The pixel arrays 135 and 145 can produce portions of the display image 150 on separate display surfaces 160, 161 that are placed next to each other. Alternatively, the display image 150 can be formed on a single display surface, for example, by portions of the display image 150 projected by the pixel arrays 135 and 145.

When a very large display image 150 is desired, it is often difficult to produce such an image on a single display device with a single imager. For example, fabricating a large pixel array including 12,000 by 8,000 tiltable mirrors may result in decreased manufacturing yield. Thus, separate smaller pixel arrays 135, 145 (e.g. arrays of 1000 by 1500 or 2000 by 3000 tiltable mirrors) are more readily constructed on different substrates. The substrates can be different dies that are fabricated from different semiconductor wafers or the same semiconductor wafer. The substrates can also be made of materials other than semiconductor materials. In some embodiments, the substrate for the first pixel array 135 or the second pixel array 145 is formed from silicon based semiconductor substrate such as complementary metal oxide semiconductor (CMOS) substrate. In some embodiments, the pixel array 135 (or 145) includes the addressing circuit 137 (or 147) and both the pixel array and addressing circuit are constructed on a single CMOS substrate. Although the display system 100 is shown with only two imagers, the display system 100 can be readily scaled to include three or more pixel arrays each having its associated addressing circuit to produce larger display images. The control circuit 110 is constructed on a different substrate from the substrates for the pixel arrays 135, 145. The reset circuit 120 is either built on the same substrate as the control circuit 110 or on its own separate substrate.

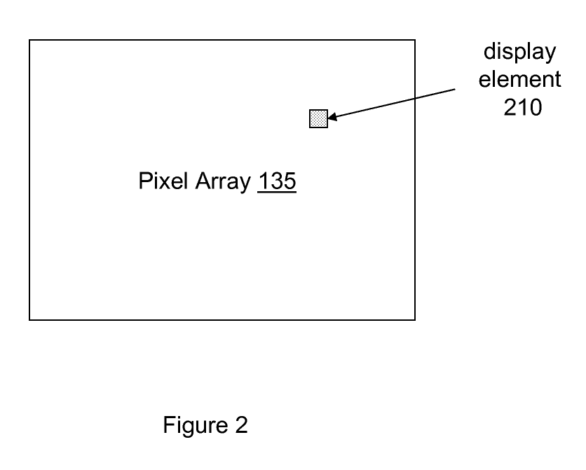

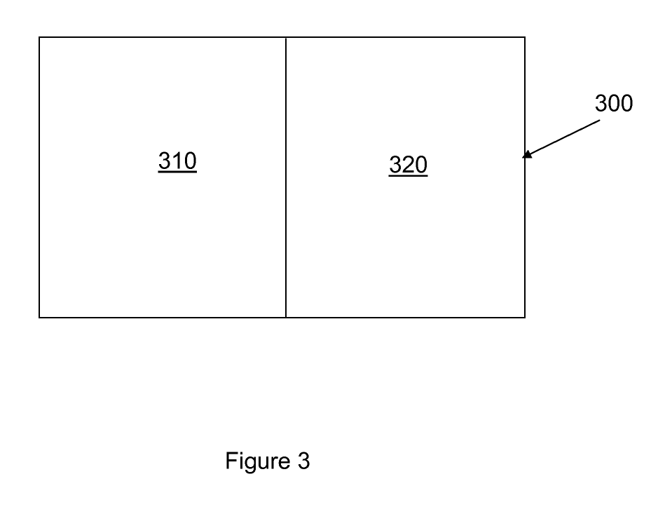

The pixel array 135 (or 145), as shown in FIG. 2, includes an array of display elements 210 (only one display element is shown for simplicity). For example, the display elements 210 can be distributed in periodic rows and columns. Alternatively, the display elements are distributed in another pattern, such as a honeycomb pattern or a circular based pattern. The display element 210 can be formed by a spatial light modulator such as a tiltable micro mirror, which can be controlled by electric signals to direct an incident light to form a pixel of a display image on the display surface 160. The display element 210 includes electrodes 221, 222 for controlling the brightness at different pixels in the display image 150 in response to the electric control signals. For example, a tiltable micro mirror at the display element 210 includes a tiltable micro mirror having a reflective upper layer and supported by a post on a substrate, an electrode on the mirror plate, and one or two electrodes on the substrate. Electric signals produce potential difference between the electrode on the mirror plate and the electrodes on the substrate. The resulting electrostatic forces cause the mirror plate to tilt an “on” position and an “off” position. When the mirror plate is tilted to the “on” position, the micro mirror at the display element 210 directs incident light from the light source 170 to form an image pixel of the display image 150 on the display surface 160. When the mirror plate is tilted to the “off” position, the micro mirror directs the incident light away from the display surface 160.

The control circuit 110 includes image processing features that divide an input digital image into a first image portion 310, to be displayed by the first imager 130, and a second image portion 320, to be displayed by the second imager 140, as shown in FIG. 2. Each of the first image portion 310 and the second image portion 320 is a contiguous zone, which for example can be rectangular shaped. The first image portion 310 and the second image portion 320 can have the same shape and the same number of pixels along its wide and height directions such that they can be displayed by identical pixel arrays, which makes the display system 100 easier to implement.

The combined display of the first image portion 310 and the second image portion 320 can form a continuous display image 150 that represents the input digital image 300. In some embodiments, the control circuit 110 determines the coordinates (x1, y1) of the pixels and associated pixel values in the first image portion 310, wherein the coordinates (x1, y1) denote the display element 210's locations such as column and row designation, in the first image portion 310. The control circuit 110 can also determine the coordinates (x2, y2) of the pixels and associated pixel values in the second image portion 320, wherein the coordinates (x2, y2) can denote the display element 210's location, such as column and row designation, in the second image portion 320. The display system 100 can include a matrix of identical pixel arrays (comprising, for example, 3×1, 2×2, 2×3, 4×4 of pixel arrays, etc.). The input digital image can be divided by a matrix of image portions consistent with the arrangement of the pixel arrays. The matrix of pixel arrays can respectively display the matrix of image portions to form the display image.

The control circuit 110 includes circuits for producing electric signals for controlling the display element 210. For example, the control circuit 110 can produce electric voltage pulses having correct amplitude, polarity, pulse form, and pulse width for driving tiltable micro mirrors at the display element 210. The addressing circuit 137 (or 147) can route the control signals to the proper display element 210 in the array 135 (or 145). The addressing circuit 137 (or 147) includes circuit components such as a row register, a column register, input and output circuits, and optionally drivers for amplifying the control signals.

The display image 150 can include a plurality of color planes such as red, green, and blue color image planes that superimpose to form a color image. Each color plane can also include a plurality of bit planes that together can create the effects of multiple bits per pixel (i.e., more than 1 bit in bit depth). After the display of each color plane or each bit plane, the reset circuit 120 sends reset signal to the pixel arrays 135 and 136 to simultaneously reset the displaying elements in the pixel arrays 135 and 136. The resetting operation completes the color plane or bit plane and prepares the display of the next color plane or bit plane for both the first image portion 310 and the second image portion 320. Because the a signal is sent to multiple pixel arrays simultaneously, in some embodiments, the system includes a single reset device for multiple pixels arrays, such as for all of the pixels arrays. A single reset device can ensure that the color planes or bit planes are reset at the same time. This allows the various portions of the complete display image to appear to be formed and controlled by a singular device, rather than to be separate non-synchronized images. Further, a single reset for all pixel array reduces the circuitry required for each pixel array or imager.

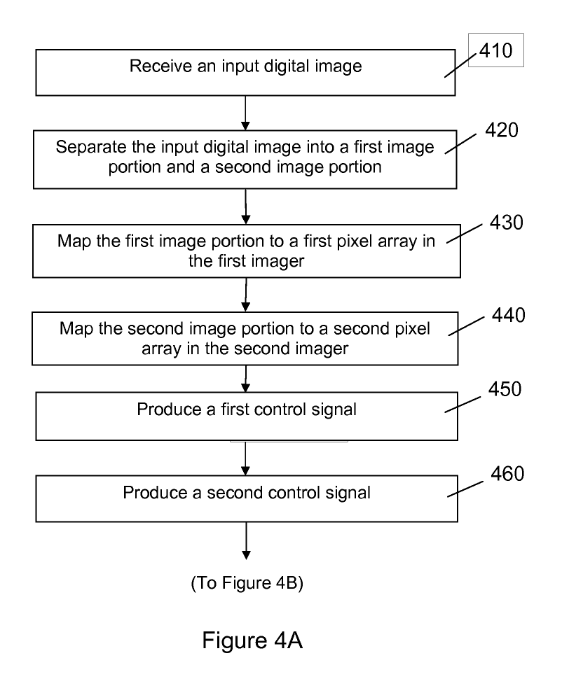

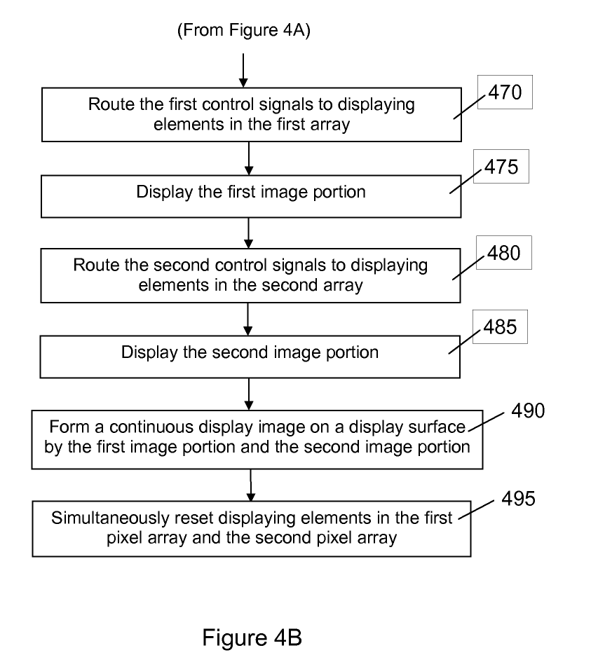

Referring to FIGS. 4A and 4B, the operation of the display system can include the following steps. An input digital image is first received by the control circuit (step 410). The control circuit then separates the input digital image into a first image portion and a second image portion (step 420). If the display system includes more than two imagers that collectively produce a display image on one or more display surfaces, such as three, four, five or more imagers, the input digital image can be divided into the same number of image portions as the number imagers. The first image portion is mapped to the first pixel array in the first imager (step 430). The mapping includes calculating the pixel value at each display element in the first imager. Similarly, the second image portion is mapped to the second pixel array in the second imager (step 440).

The control circuit then produces first control signals for controlling the display elements in the first pixel array (step 450). The first control signals control the display elements in the first pixel array in accordance with the pixel values to be displayed by each display element. Likewise, the control circuit also produces second control signals for controlling the display elements in the second pixel array (step 460). The second control signals control the display elements in the second pixel array in accordance with the pixel values to be displayed by each display element.

The first control signals are routed to the displaying elements in the first pixel array by the addressing circuit (step 470). The displaying elements are turned on or off by the first control signals to display the first image portion on the display surface (step 475). The second control signals are also routed to the displaying elements in the second pixel array by the addressing circuit (step 480). The displaying elements in the second pixel array are turned on or off by the second control signals to display the second image portion on the display surface (step 475). The control circuit synchronizes the first and second control signals such that the first image portion and the second image portion are simultaneously displayed such that they can form a continuous display image on the display surface (step 490). The displaying elements in the first pixel array and the second pixel array are kept on or off for a fixed time interval (i.e., the length of a bit plane). The display of the display image can include displaying several color planes each including one or more bit planes.

After a bit plane is displayed by the first pixel array and the second pixel array, the reset circuit sends a reset signal to the first pixel array and the second pixel array to simultaneously reset the displaying elements in first pixel array and the second pixel array (step 495). The first pixel array and the second pixel array are then ready to display the next bit plane for the display image. Since the first pixel array and the second pixel array are reset by reset signals from the same reset circuit, the display elements in the first pixel array and the second pixel array can be better synchronized between bit planes, which can reduce image artifacts such as flickering caused by timing differences between different pixel arrays in a convention display systems.

The disclosed display apparatus may use fewer components and may thus be more integrated and more compact than some conventional display systems. The disclosed display apparatus can readily be scaled to produce large display images with few components and thus lower cost than some conventional display systems. The disclosed display apparatus may consume less power than some conventional display systems. The disclosed display apparatus may also provide improved synchronization between different portions of a display image, which may improve the quality of the display images.

It is understood that the pixel arrays in the disclosed systems and methods are compatible with a wide range of display technologies such as liquid crystal displays (LCD), light emitting diodes (LED) displays, organic light emitting diode (OLED) displays, laser diode displays, scanning displays, and projection displays using spatial light modulators (SLM) such as tiltable micro mirror arrays or liquid crystals on a semiconductor chip. The disclosed systems and methods are also suitable for projection-type and transmissive-type display systems.

What is claimed is:

1. An apparatus for displaying a digital image, comprising:
a controller configured to separate the digital image into a first image portion and a second image portion, and to produce a first control signal based on the first image portion and a second control signal based on the second image portion;
a first addressing circuit in communication with the controller, the first addressing circuit being configured to produce first addressing signals in response to the first control signal;
a first array of displaying elements configured to display the first image portion in response to the first addressing signals;
a second addressing circuit in communication with the controller, the second addressing circuit being configured to produce second addressing signals in response to the second control signal;
a second array of displaying elements configured to display the second image portion in response to the second addressing signals, wherein the first array of image displaying elements and the second array of image displaying elements are constructed on different substrates; and
a reset circuit in communication with the controller, the first array of displaying elements, and the second array of displaying elements, wherein the reset circuit is configured to simultaneously reset the first array of displaying elements and the second array of displaying elements.

2. The apparatus of claim 1, wherein the first array of displaying elements and the first addressing circuit are constructed on a first substrate, and wherein the second array of displaying elements and the second addressing circuit are constructed on a second substrate and the controller is constructed on a third substrate, which is different than both of the first substrate and the second substrate.

3. The apparatus of claim 2, wherein the reset circuit is constructed on the third substrate.

4. The apparatus of claim 1, further comprising a display surface on which a continuous display image is formed by the first image portion and the second image portion.

5. The apparatus of claim 1, further comprising a light source configured to provide incident light to at least one of the first array of displaying elements or the second array of displaying elements.

6. The apparatus of claim 1, wherein the first addressing signals are configured to control the first array of displaying elements based on pixel values in the first image portion.

7. The apparatus of claim 6, wherein the second addressing signals are configured to control the second array of displaying elements based on pixel values in the second image portion.

8. The apparatus of claim 1, wherein at least one of the displaying elements in the first array comprises a tiltable micro mirror configured to tilt under the control of the first addressing signal and to reflect an incident light to a display surface to form a pixel of the first image portion.

9. An apparatus for displaying a digital image, comprising:
a controller configured to separate the digital image into a first image portion and a second image portion, and to produce a first control signal based on the first image portion and a second control signal based on the second image portion, wherein the controller circuit is constructed on a first substrate;
a first addressing circuit in communication with the controller, the first addressing circuit configured to produce first addressing signals in response to the first control signal;
a first array of displaying elements configured to display the first image portion in response to the first addressing signals, wherein the first array of displaying elements and the first addressing circuit are constructed on a second substrate that is different from the first substrate;
a second addressing circuit in communication with the controller, the second addressing circuit configured to produce second addressing signals in response to the second control signal;
a second array of displaying elements configured to display the second image portion in response to the second addressing signals wherein the second array of displaying elements and the second addressing circuit are constructed on a third substrate, which is different from both the first substrate and the second substrate; and
a reset circuit in communication with the controller, the first array of displaying elements, and the second array of displaying elements, wherein the reset circuit is configured to simultaneously reset the first array of displaying elements and the second array of displaying elements.

10. The apparatus of claim 9, further comprising a light source configured to provide an incident light to at least one of the first array of displaying elements and the second array of displaying elements.

11. The apparatus of claim 9, further comprising a display surface on which a continuous display image is formed by the first image portion and the second image portion.

12. The apparatus of claim 9, wherein the reset circuit is constructed on the first substrate.

13. The apparatus of claim 9, wherein the first addressing signals are configured to control the first array of displaying elements based on pixel values in the first image portion.

14. The apparatus of claim 9, wherein the second addressing signals are configured to control the second array of displaying elements based on pixel values in the second image portion.

15. The apparatus of claim 9, wherein at least one of the displaying elements in the first array comprises a tiltable micro mirror configured to tilt under the control of the first addressing signal and to reflect an incident light to a display surface to form a pixel of the first image portion on the display surface.

16. A method for image display, comprising:
separating a digital image into a first image portion and a second image portion;
producing a first control signal based on the first image portion and a second control signal based on the second image portion;
producing first addressing signals in response to the first control signal and sending the first addressing signals to a first array of displaying elements;
displaying the first image portion in response to the first addressing signals;
producing second addressing signals by a second addressing circuit in response to the second control signal and sending the second addressing signals to a second array of displaying elements;
displaying the second image portion in response to the second addressing signals; and
simultaneously resetting the first array of displaying elements and the second array of displaying elements with a single reset signal.

17. The method of claim 16, further comprising forming a continuous display image on a display surface by the first image portion and the second image portion.

18. The method of claim 16, wherein the step of displaying the first image portion comprises:
providing an incident light to the first array of displaying elements;
controlling the first array of displaying elements based on pixel values in the first image portion of the input digital image; and
selectively directing the incident light to a display surface to form the first image portion.

19. The method of claim 18, wherein displaying the first image portion includes:
tilting a tiltable micro mirror in response to the control of the first addressing signal; and
reflecting an incident light to the display surface to form a pixel of the first image portion on the display surface.
